(19) United States
(12) Patent Application Publication
(10) Pub. No.: US 2005/0193390 A1
(43) Pub. Date: Sep. 1, 2005

(54) Program downloading method, program switching method and network apparatus

(75) Inventors: Toshihiro Suzuki, Kawasaki (JP); Eiji Iida, Kawasaki (JP); Miwa Taniguchi, Kawasaki (JP); Tomoyuki Kanzaki, Kawasaki (JP); Kazuaki Nagamine, Kawasaki (JP); Takuma Shouji, Kawasaki (JP); Shingo Hara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/879,142

(22) Filed: Jun. 30, 2004

(30) Foreign Application Priority Data
Feb. 26, 2004 (JP) 2004-051970

(51) Int. Cl. G06F 9/445

(52) U.S. Cl. 717/178

(57) ABSTRACT

A program downloading method downloads a program from a host unit to a plurality of network apparatuses. The program downloading method includes sending a configuration file comprising a main configuration file and a plurality of configuration files from the host unit to the plurality of network apparatuses, acquiring in each network apparatus a sub configuration file corresponding to a system type thereof from a main configuration file of the received configuration file, making from each network apparatus a send request requesting the host unit to send a load module name and a version required therein, based on a sub configuration file corresponding to the system type thereof, and storing in a standby memory of each network apparatus a load module which is received from the host unit in response to the send request.

### BACKGROUND OF THE INVENTION

This application claims the benefit of a Japanese Patent Application No. 2004-051970 filed Feb. 26, 2004, in the Japanese Patent Office, the disclosure of which is hereby incorporated by reference.

1. Field of the Invention

The present invention generally relates to program downloading methods, program switching methods and network apparatuses, and more particularly to a program downloading method for downloading a program to a plurality of network apparatuses, a program switching method for switching the program downloaded to the plurality of network apparatuses, and a network apparatus to which such a downloading of the program is carried out.

2. Description of the Related Art

In network systems, an operating program is downloaded to network apparatuses such as transmission apparatuses, and the operating program of each network apparatus is updated if necessary.

A description will be given of an example of a conventional procedure for updating the operating program of the transmission apparatus to a new program, by referring to FIG. 1. FIG. 1 is a system block diagram showing a part of an example of the transmission apparatus for processing a downloading. In a transmission apparatus 10 shown in FIG. 1, a first memory 11 stores an operating program, and a second memory 12 also stores an operating program. An operating program storing memory storage 13 stores information indicating which one of the operating programs stored in the first and second memories 11 and 12 is to be used as the operating program of the transmission apparatus 10 or, which one of the first and second memories 11 and 12 stores the operating program to be used. A CPU 14 controls the transmission apparatus 10. A load module is developed in an operation memory 15 when the CPU 14 executes the program.

In the following description, it is assumed for the sake of convenience that the first memory 11 is set in the operating program storing memory storage 13, such that the first memory 11 is set as a working memory and the second memory 12 is set as a standby memory. In this case, when an update request to update the operating program to a new program is received from a host unit 16, downloading and updating of the program are carried out according to the following procedure.

In a first step, the CPU 14 receives from the host unit 16 a download request to download the new program.

In a second step, the CPU 14 starts downloading from the host unit 16 a configuration file which stores the new program and version information of the new program, and stores the configuration file in the second memory 12.

In a third step, the CPU 14 receives from the host unit 16 a switch request to switch the operating program.

In a fourth step, the CPU 14 updates the information stored in the operating program storing memory storage 13 to the second memory 12, and restarts the CPU 14. Since the information stored in the operating program storing memory storage 13 indicates the second memory as the working memory, the restarted CPU 14 develops the new program stored in the second memory 12 into the operation memory 15, and resumes the control.

On the other hand, a Japanese Laid-Open Patent Application No. 2001-296994 proposes downloading a program to a large number of terminals from a head end apparatus via a network, and inspecting a current (or newest) software version table to confirm the current software version at each terminal. Each terminal judges by itself whether or not to download all of the programs of the current software version.

Further, a Japanese Laid-Open Patent Application No. 2000-353096 proposes sending current (or newest) program block information from a central station to a base station. The base station compares the current program block information that is received with program block information thereof, and requests to the central station only the program blocks not presently stored in the base station. Hence, the base station updates the program thereof to the current state by downloading all of the requested program blocks.

However, the following problems occurred when updating the operating program according to the conventional procedures.

Conventionally, when updating the program to the current version, the entire new program is downloaded from the host unit or station. But the functions to be supported differ depending on the transmission apparatuses, even for the transmission apparatuses provided within the same network system, because there are various operations and types of the transmission apparatuses. For example, the transmission apparatuses may include a transmitting station which carries out both light multiplexing and light amplification, and a relay station which only carries out light amplification. However, even though the operations and types of the transmission apparatus may differ, the program corresponding to all of the operations and types is downloaded, thereby carrying out the downloading also with respect to unnecessary functions. In addition, the downloading is carried out also with respect to the module which is not modified. Consequently, the amount of information to be downloaded does not change regardless of the operation and type of each transmission apparatus and the amount of modified modules. In other words, the downloading takes a maximum download time required to download the program corresponding to all of the operations and types, with respect to each transmission apparatus.

Further, when updating the operating program to the current version, it is conventionally essential to restart the CPU. For this reason, after the CPU is restarted, a non-monitoring state in which alarms and the like are not monitored is generated until a normal processing starts. In addition, in a case where a host monitoring apparatus or the like logs into the transmission apparatus, it is necessary to make the log-in again after the CPU is restarted, thereby temporarily increasing a load on the network due to the log-in that is carried out again.

### SUMMARY OF THE INVENTION

Accordingly, it is a general object of the present invention to provide a novel and useful program downloading method, program switching method and network apparatus, in which the problems described above are suppressed.

Another and more specific object of the present invention is to provide a program downloading method, a program switching method and a network apparatus, which can reduce a program download time and switch the programs without the need for a restart.

Still another object of the present invention is to provide a program downloading method for downloading a program from a host unit to a plurality of network apparatuses, each of the plurality of network apparatuses having a CPU, an operation memory used for program execution, a working memory and a standby memory, the program downloading method comprising the steps of (a) sending a configuration file comprising a main configuration file and a plurality of configuration files from the host unit to the plurality of network apparatuses, the plurality of sub configuration files having a load module name, a version, and information indicating whether or not to restart the CPU when each load module is developed in the operation memory written therein for each system type of the network apparatus, the main configuration file having a correspondence of each of the plurality of sub configuration files and the system type of each of the plurality of network apparatuses written therein; (b) acquiring in each of the plurality of network apparatuses a sub configuration file corresponding to a system type thereof from the main configuration file of the received configuration file; (c) making from each of the plurality of network apparatuses a send request requesting the host unit to send a load module name and a version required therein, based on a sub configuration file corresponding to the system type thereof; and (d) storing in the standby memory of each of the plurality of network apparatuses a load module which is received from the host unit in response to the send request. According to the program loading method of the present invention, it is possible to download only the required load modules and to reduce the download time.

A further object of the present invention is to provide a program switching method for switching an operation program, after downloading a load module from the host unit to the plurality of network apparatuses according to the program downloading method described above, to the downloaded load module, comprising the steps of (i) switching the standby memory to the working memory in each of the plurality of network apparatuses in response to a switch request from the host unit; (ii) developing from the working memory to the operation memory a load module having the same load module name but a different version, of the load modules developed in the operation memory and the load modules written in the sub configuration file stored in the working memory, and developing from the working memory to the operation memory a load module not developed in the operation memory but written in the sub configuration file stored in the working memory, when developing the load modules stored in the working memory in the operation memory; and (iii) restarting the CPU if information indicating whether or not the CPU is to be restarted indicates the restarting with respect to the load module developed in the operation memory. According to the program switching method of the present invention, it is possible to switch a program which does not require restarting of the CPU.

Another object of the present invention is to provide a program switching method for re-switching an operation program, after downloading a load module from the host unit to the plurality of network apparatuses according to the program downloading method described above, to the downloaded load module and switching the downloaded load module, comprising the steps of (i) switching the standby memory to the working memory in each of the plurality of network apparatuses in response to a re-switch request from the host unit; (ii) developing from the working memory to the operation memory a load module having the same load module name but a different version, of the load modules developed in the operation memory and the load modules written in the sub configuration file stored in the working memory, and developing from the working memory to the operation memory a load module not developed in the operation memory but written in the sub configuration file stored in the working memory, when developing the load modules stored in the working memory in the operation memory; and (iii) restarting the CPU if information indicating whether or not the CPU is to be restarted indicates the restarting with respect to the load module developed in the operation memory. According to the program switching method of the present invention, it is possible to switch a program which does not require restarting of the CPU.

Still another object of the present invention is to provide a network apparatus to which a program is downloaded from a host unit, comprising a CPU; an operation memory used for program execution by the CPU; a working memory; and a standby memory, the CPU comprising an acquiring unit configured to receive from the host unit a configuration file comprising a main configuration file and a plurality of sub configuration file, and to acquire from the main configuration file of the received configuration file a sub configuration file corresponding a system type of the network apparatus, the plurality of sub configuration files having a load module name, a version, and information indicating whether or not to restart the CPU when each load module is developed in the operation memory written therein for each system type of the network apparatus, the main configuration file having a correspondence of each of the plurality of sub configuration files and the system type of each of the plurality of network apparatuses written therein; a request unit configured to send to the host unit a send request requesting the host unit to send a load module name and a version required by the network apparatus, based on the sub configuration file corresponding to the system type of the network apparatus; and a storage unit configured to store in the standby memory a load module received from the host unit in response to the send request. According to the network apparatus of the present invention, it is possible to download only the required load modules and to reduce the download time.

Other objects and further features of the present invention will be apparent from the following detailed description when read in conjunction with the accompanying drawings.

### BRIEF DESCRIPTION OF THE DRAWINGS

FIG. 1 is a system block diagram showing a part of an example of a transmission apparatus for processing a downloading;

FIG. 2 is a diagram showing a network system which may be applied with a program downloading method according to the present invention;

FIGS. 3A and 3B are diagrams for explaining an embodiment of configuration files;

FIG. 4 is a flow chart for explaining a first embodiment of the program downloading method according to the present invention;

FIG. 5 is a flow chart for explaining the first embodiment of the program downloading method according to the present invention;

FIG. 6 is a flow chart for explaining a second embodiment of the program downloading method according to the present invention;

FIG. 7 is a flow chart for explaining the second embodiment of the program downloading method according to the present invention;

FIG. 8 is a flow chart for explaining a third embodiment of the program downloading method according to the present invention;

FIG. 9 is a flow chart for explaining the third embodiment of the program downloading method according to the present invention;

FIG. 10 is a flow chart for explaining a first embodiment of a program switching method according to the present invention;

FIG. 11 is a flow chart for explaining the first embodiment of the program switching method according to the present invention;

FIG. 12 is a flow chart for explaining a second embodiment of the program switching method according to the present invention; and

FIG. 13 is a flow chart for explaining the second embodiment of the program switching method according to the present invention.

### DESCRIPTION OF THE PREFERRED EMBODIMENTS

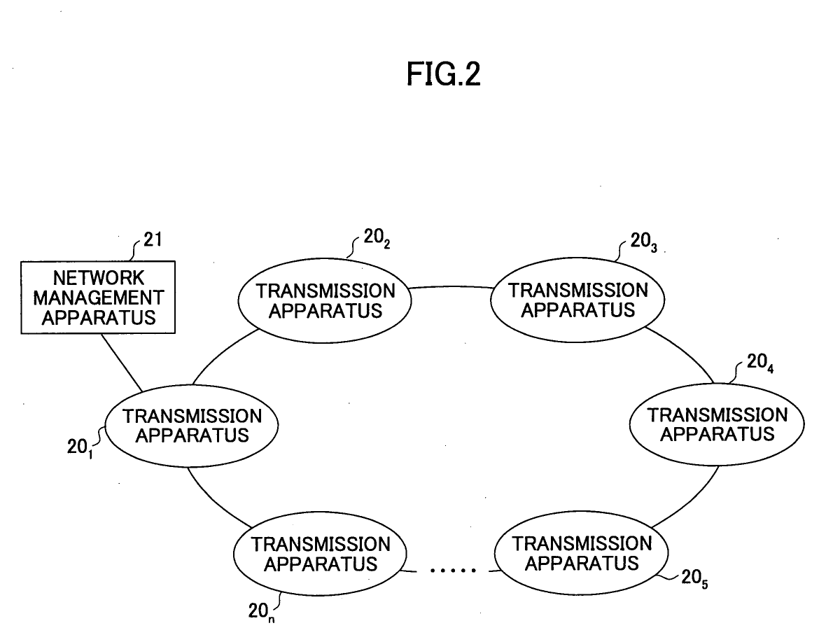

FIG. 2 is a diagram showing a network system which may be applied with a program downloading method according to the present invention. In FIG. 2, transmission apparatuses 20₁ through 20ₙ form a ring network, where n is an integer greater than or equal to 2. A network management apparatus 21 is connected to the transmission apparatus 20₁ as a host unit. The transmission apparatuses 20₂ through 20ₙ are connected to the network management apparatus 21 via the ring network and the transmission apparatus 20₁.

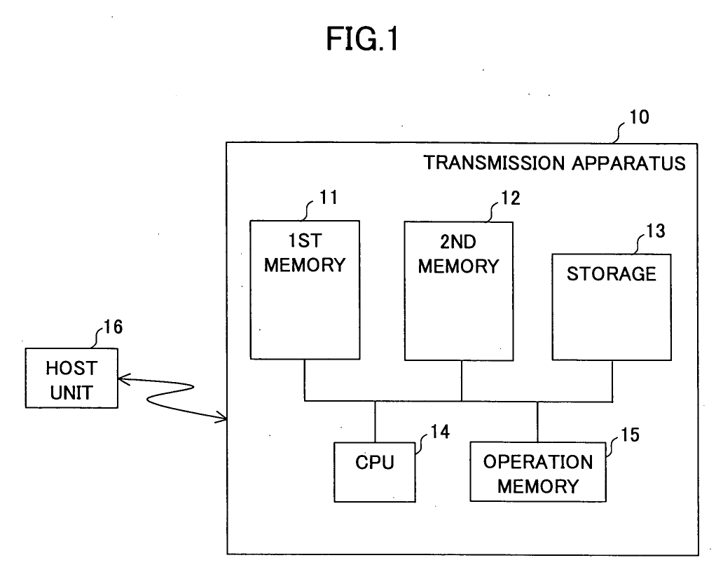

In the program downloading method according to the present invention and a program switching method according to the present invention, a part which processes the downloading of the transmission apparatus has the same structure as the corresponding part shown in FIG. 1. In the present invention, the first memory 11 stores an operating program, and the second memory 12 also stores an operating program. The operating program storing memory storage 13 stores information indicating which one the first and second memories 11 and 12 stores the operating program to be used. The CPU 14 controls the transmission apparatus. A load module is developed in an operation memory 15 when the CPU 14 executes the program.

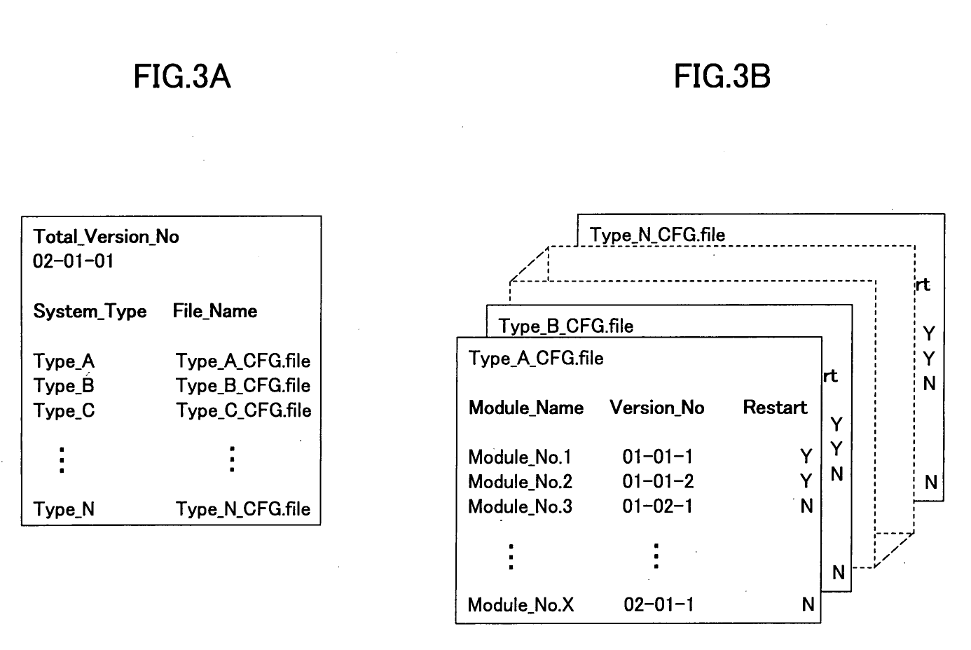

FIGS. 3A and 3B are diagrams for explaining an embodiment of configuration files which are used by the program downloading method according to the present invention and the program switching method according to the present invention. A configuration file “Config.file” is made up of one main configuration file “mainconfig.file” shown in FIG. 3A and a plurality of sub configuration files “subconfig.file” shown in FIG. 3B.

A total version number “Total_Version_No” of the operating program, each system (or operation) type “System_Type” of the transmission apparatus, and a corresponding sub configuration file name “File_Name” are written in the main configuration file “mainconfig.file”.

The sub configuration file “subconfig.file” exists for each system (or operation) type. A load module name “Module_Name” that is required, a version number “Version_No” thereof, and information “Restart” indicating whether or not the CPU 14 is to be restarted when the load module is developed in the operation memory 15 are written in the sub configuration file “subconfig.file” of each system (or operation) type.

Next, a description will be given of a first embodiment of the program downloading method according to the present invention. When a download request that requests downloading of a new program is generated from the network management apparatus 21, that is, the host unit 16, this embodiment downloads the new program according to the following procedure. The transmission apparatus in this embodiment forms a first embodiment of the network apparatus according to the present invention.

In a first step, the CPU 14 receives the download request from the host unit 16 requesting downloading of the new program.

In a second step, the CPU 14 receives a configuration file for the new program from the host unit 16.

In a third step, the CPU 14 selects a sub configuration file corresponding to the system type of the transmission apparatus to which the CPU 14 belongs, from a main configuration file within the received configuration file, and downloads only a load module written in the sub configuration file from the host unit 16. In addition, the load module that is downloaded is stored in the second memory 12 which is used as the standby memory.

In a fourth step, the CPU 14 replaces the configuration file stored in the second memory 12 by the configuration file for the new program.

By the above described procedure, the CPU 14 downloads into the second memory 12 the configuration file for the new program and only the load module that is necessary for the transmission apparatus to which the CPU 14 belongs to operate. Hence, it is possible to store in the second memory 12 all of a module group specified by the configuration file and the configuration file for the new program.

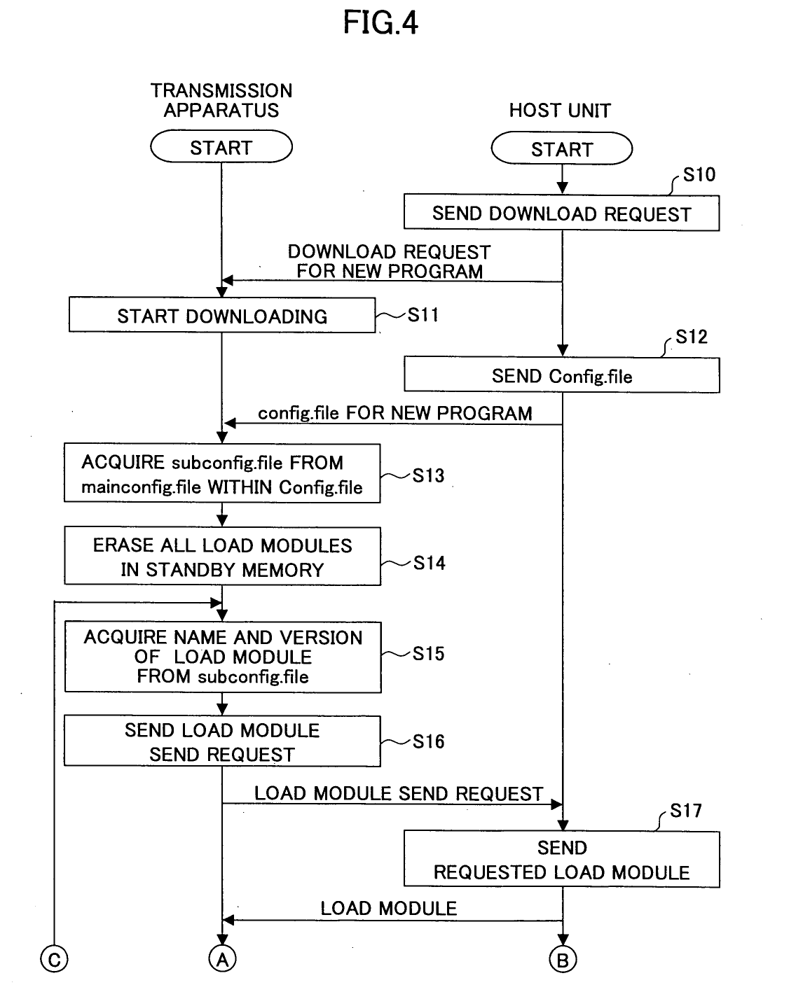

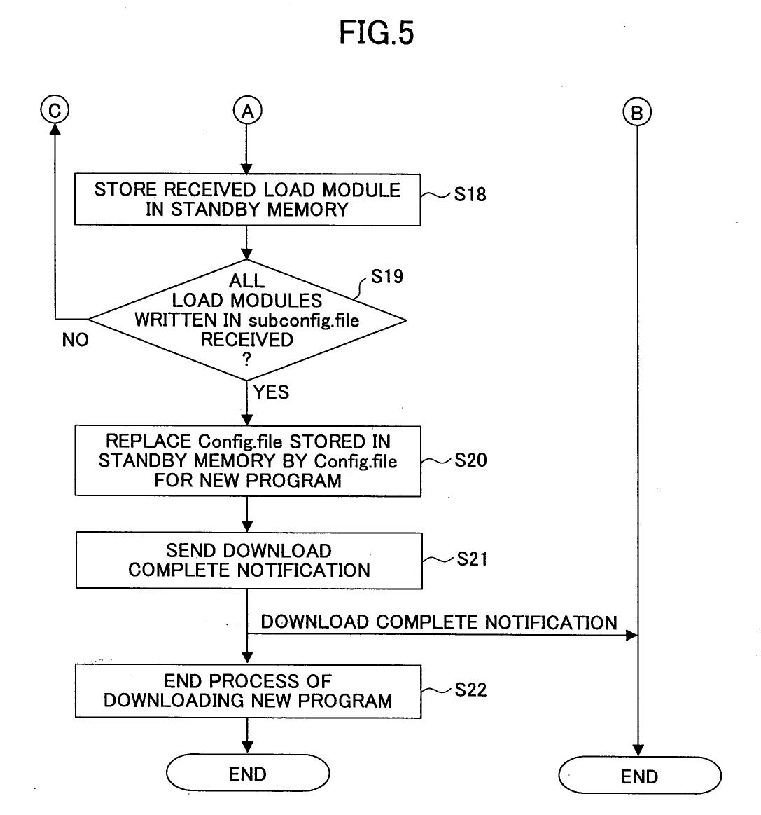

FIGS. 4 and 5 are flow charts for explaining this first embodiment of the program downloading method according to the present invention.

In a step S10 shown in FIG. 4, the host unit 16 sends a download request for the new program to the transmission apparatus. In a step S11, the CPU 14 of the transmission apparatus which receives the download request for the new program starts downloading the new program.

Next, in a step S12, the host unit 16 sends a configuration file for the new program to the transmission apparatus. In a step S13, the CPU 14 of the transmission apparatus acquires a sub configuration file corresponding to the system type thereof, from a main configuration file within the received configuration file for the new program. In a step S14, the CPU 14 of the transmission apparatus erases all load modules stored in the second memory 12 which is used as the standby memory.

In a step S15, the CPU 14 of the transmission apparatus acquires a load module name and a version written in the acquired sub configuration file. In a step S16, the CPU 14 of the transmission apparatus sends to the host unit 16 a load module send request which requests sending of the load module having the acquired load module name and version. In a step S17, the host unit 16 which receives the load module send request sends the requested load module to the transmission apparatus.

In a step S18 shown in FIG. 5, the CPU 14 of the transmission apparatus receives the load module sent from the host unit 16 and stores the received load module in the second memory 12. Thereafter, in a step S19, the CPU 14 of the transmission apparatus decides whether or not all of the load modules written in the acquired sub configuration file have been received. The process returns to the step S15 shown in FIG. 4 to repeat the steps S15 through S19 if the decision result in the step S19 is NO.

On the other hand, if the decision result in the step S19 is YES, the process advances to a step S20. In the step S20, the CPU 14 of the transmission apparatus replaces the old configuration file stored in the second memory 12 by the main configuration file and the sub configuration file corresponding to the system type of the transmission apparatus, which are within the configuration file for the new program acquired in the step S13. In other words, the old configuration file stored in the second memory 12 is overwritten by the main configuration file and the sub configuration file within the configuration file for the new program. In a step S21, the CPU 14 of the transmission apparatus sends a download complete notification to the host unit 16. Thereafter, in a step S22, the CPU 14 of the transmission apparatus ends the process of downloading the new program.

Next, a description will be given of a second embodiment of the program downloading method according to the present invention. When a download request that requests downloading of a new program is generated from the network management apparatus 21, that is, the host unit 16, this embodiment downloads the new program according to the following procedure. The transmission apparatus in this embodiment forms a second embodiment of a network apparatus according to the present invention.

In a first step, the CPU 14 receives the download request from the host unit 16 requesting downloading of the new program.

In a second step, the CPU 14 receives a configuration file for the new program from the host unit 16.

In a third step, the CPU 14 selects a sub configuration file corresponding to the system type of the transmission apparatus to which the CPU 14 belongs, from a main configuration file within the received configuration file, and compares the load module stored in the second memory 12 which is used as the standby memory and the load module written in the sub configuration file corresponding to the system type of the transmission apparatus to which the CPU 14 belongs. In addition, the load module that is not stored in the second memory 12 or the load module having a different version is downloaded from the host unit 16. Furthermore, the load module that is stored in the second memory 12 but is not written in the configuration file corresponding to the system type of the transmission apparatus to which the CPU 14 belongs is deleted from the second memory 12.

In a fourth step, the CPU 14 replaces the configuration file stored in the second memory 12 by the configuration file for the new program.

By the above described procedure, the CPU 14 downloads into the second memory 12 only the load module that is not stored in the second memory 12 which is used as the standby memory. Hence, it is possible to store in the second memory 12 all of a module group specified by the configuration file and the configuration file for the new program.

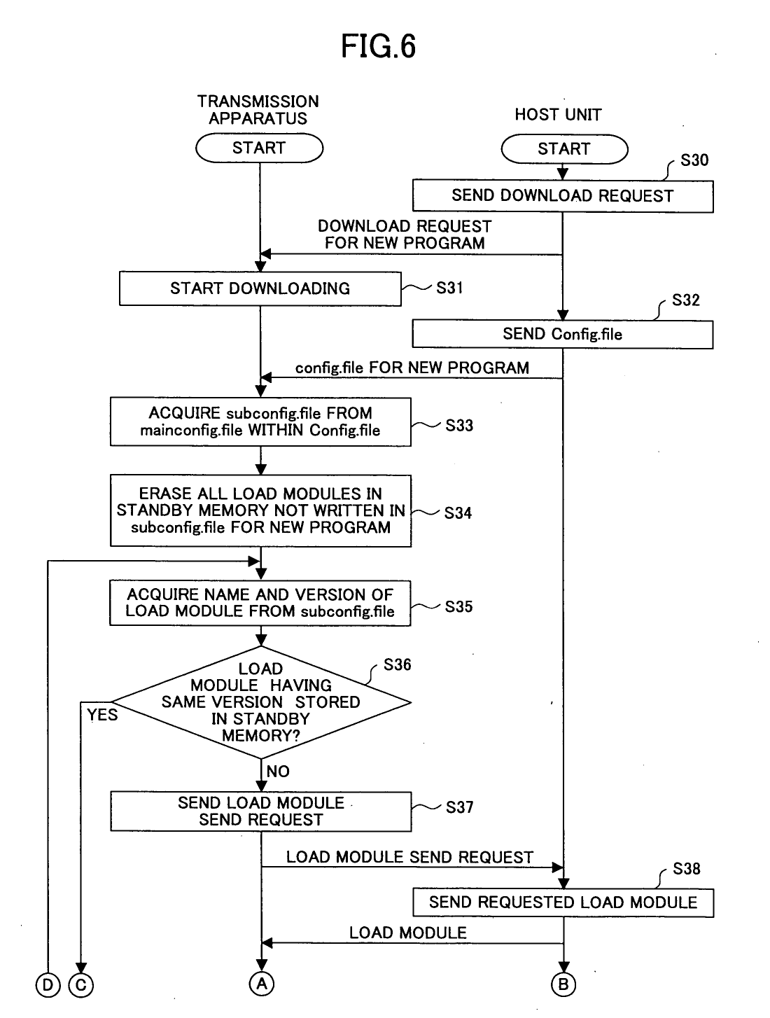

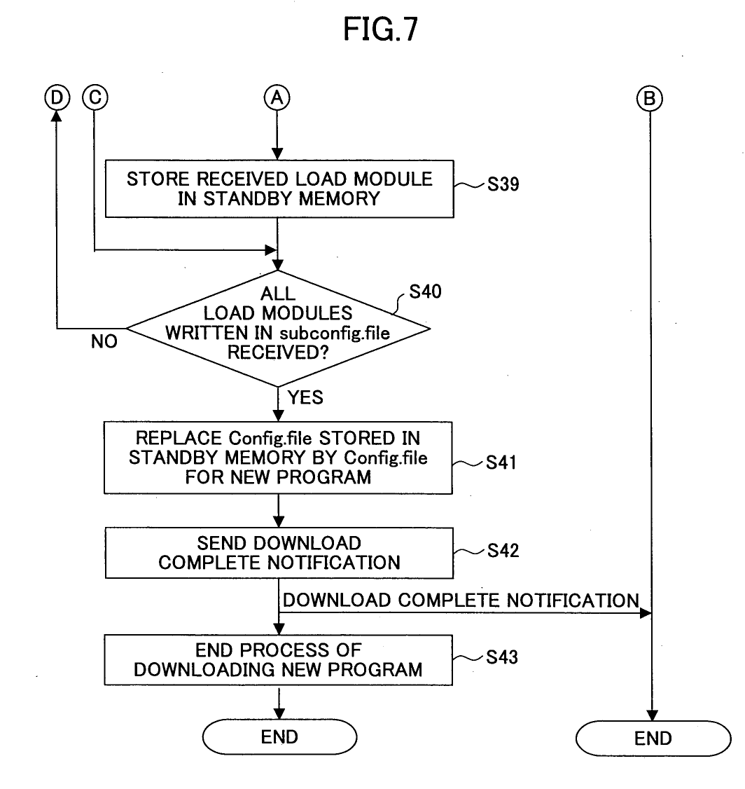

FIGS. 6 and 7 are flow charts for explaining this second embodiment of the program downloading method according to the present invention.

In a step S30 shown in FIG. 6, the host unit 16 sends a download request for the new program to the transmission apparatus. In a step S31, the CPU 14 of the transmission apparatus which receives the download request for the new program starts downloading the new program.

Next, in a step S32, the host unit 16 sends a configuration file for the new program to the transmission apparatus. In a step S33, the CPU 14 of the transmission apparatus acquires a sub configuration file corresponding to the system type thereof, from a main configuration file within the received configuration file for the new program. In a step S34, the CPU 14 of the transmission apparatus erases all load modules not written in the acquired sub configuration file, of the load modules stored in the second memory 12 which is used as the standby memory.

In a step S35, the CPU 14 of the transmission apparatus acquires a load module name and a version written in the acquired sub configuration file. In a step S36, the CPU 14 of the transmission apparatus decides whether nor not a load module having the same version as the acquired load module name is stored in the second memory 12 which is used as the standby memory. The process advances to a step S37 if the decision result in the step S36 is NO, and the process advances to a step S40 shown in FIG. 7 if the decision result in the step S36 is YES.

In the step S37, the CPU 14 of the transmission apparatus sends to the host unit 16 a load module send request which requests sending of the load module having the acquired load module name and version. In a step S38, the host unit 16 which receives the load module send request sends the requested load module to the transmission apparatus.

In a step S39 shown in FIG. 7, the CPU 14 of the transmission apparatus receives the load module sent from the host unit 16 and stores the received load module in the second memory 12. Thereafter, in the step S40, the CPU 14 of the transmission apparatus decides whether or not all of the load modules written in the acquired sub configuration file have been received. The process returns to the step S35 shown in FIG. 6 to repeat the steps S35 through S40 if the decision result in the step S40 is NO.

On the other hand, if the decision result in the step S40 is YES, the process advances to a step S41. In the step S41, the CPU 14 of the transmission apparatus replaces the old configuration file stored in the second memory 12 by the main configuration file and the sub configuration file corresponding to the system type of the transmission apparatus, which are within the configuration file for the new program acquired in the step S33. In other words, the old configuration file stored in the second memory 12 is overwritten by the main configuration file and the sub configuration file within the configuration file for the new program. In a step S42, the CPU 14 of the transmission apparatus sends a download complete notification to the host unit 16. Thereafter, in a step S43, the CPU 14 of the transmission apparatus ends the process of downloading the new program.

Next, a description will be given of a third embodiment of the program downloading method according to the present invention. When a download request that requests downloading of a new program is generated from the network management apparatus 21, that is, the host unit 16, this embodiment downloads the new program according to the following procedure. The transmission apparatus in this embodiment forms a third embodiment of the network apparatus according to the present invention.

In a first step, the CPU 14 receives the download request from the host unit 16 requesting downloading of the new program.

In a second step, the CPU 14 receives a configuration file for the new program from the host unit 16.

In a third step, the CPU 14 selects a sub configuration file corresponding to the system type of the transmission apparatus to which the CPU 14 belongs, from a main configuration file within the received configuration file, and compares the load module stored in the second memory 12 which is used as the standby memory and the load module written in the sub configuration file corresponding to the system type of the transmission apparatus to which the CPU 14 belongs. In addition, if the load module that is not stored in the second memory 12 or the load module having a different version is written in the sub configuration file corresponding to the system type of the transmission apparatus to which the CPU 14 belongs, a check is made to confirm whether or not a load module having the same load module name and the same version is stored in the first memory 11 which is used as the working memory, and if in the affirmative copies the load module from the first memory 11 to the second memory 12. On the other hand, if no load module having the same load module name and the same version is stored in the first memory 11, the concerned load module is downloaded from the host unit 16. Furthermore, the load module that is stored in the second memory 12 but is not written in the configuration file corresponding to the system type of the transmission apparatus to which the CPU 14 belongs is deleted from the second memory 12.

In a fourth step, the CPU 14 replaces the configuration file stored in the second memory 12 by the configuration file for the new program.

By the above described procedure, the CPU 14 downloads into the second memory 12 only the load module that is not stored in both the first memory 11 which is used as the working memory and the second memory 12 which is used as the standby memory. Hence, it is possible to store in the second memory 12 all of a module group specified by the configuration file and the configuration file for the new program.

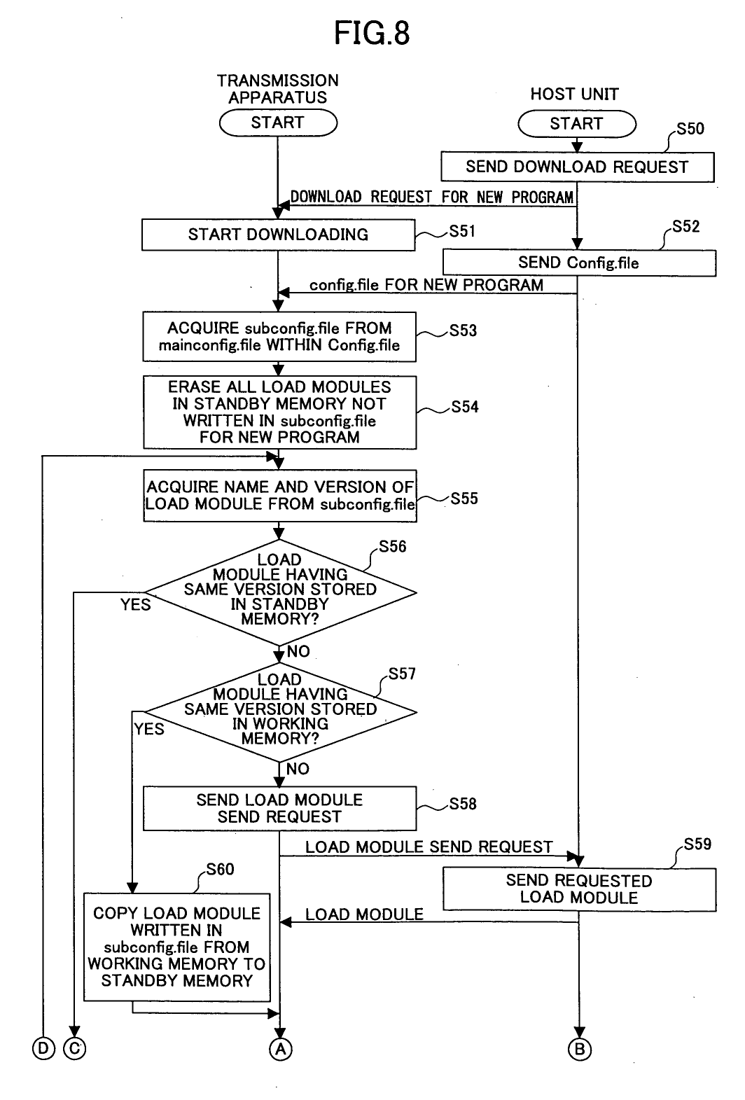

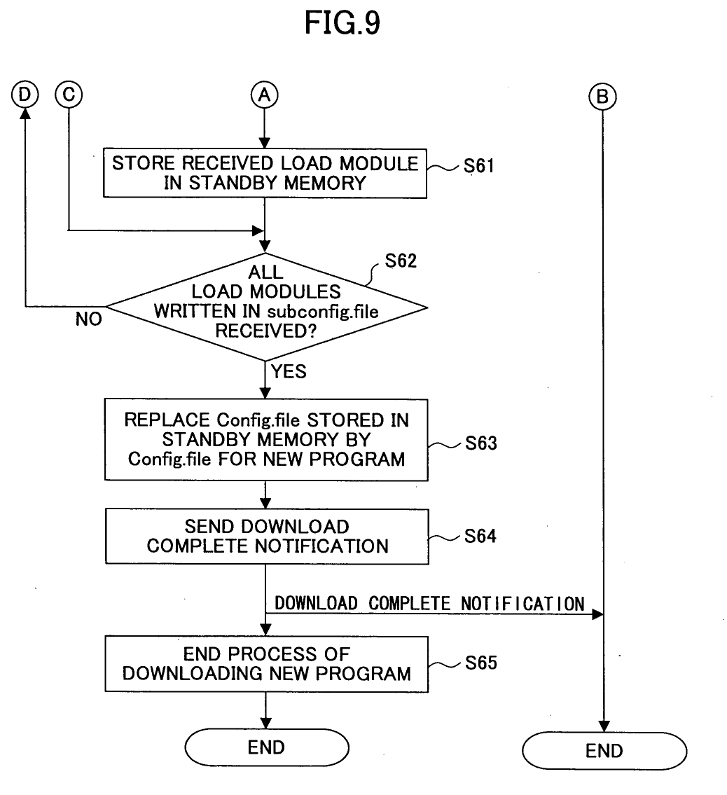

FIGS. 8 and 9 are flow charts for explaining this third embodiment of the program downloading method according to the present invention.

In a step S50 shown in FIG. 8, the host unit 16 sends a download request for the new program to the transmission apparatus. In a step S51, the CPU 14 of the transmission apparatus which receives the download request for the new program starts downloading the new program.

Next, in a step S52, the host unit 16 sends a configuration file for the new program to the transmission apparatus. In a step S53, the CPU 14 of the transmission apparatus acquires a sub configuration file corresponding to the system type thereof, from a main configuration file within the received configuration file for the new program. In a step S54, the CPU 14 of the transmission apparatus erases all load modules not written in the acquired sub configuration file, of the load modules stored in the second memory 12 which is used as the standby memory.

In a step S55, the CPU 14 of the transmission apparatus acquires a load module name and a version written in the acquired sub configuration file. In a step S56, the CPU 14 of the transmission apparatus decides whether nor not a load module having the same version as the acquired load module name is stored in the second memory 12 which is used as the standby memory. The process advances to a step S57 if the decision result in the step S56 is NO, and the process advances to a step S62 shown in FIG. 9 if the decision result in the step S56 is YES.

In the step S57, the CPU 14 of the transmission apparatus decides whether or not a load module having the same version as the acquired load module name is stored in the first memory 11 which is used as the working memory. The process advances to a step S58 if the decision result in the step S57 is NO, and the process advances to a step S60 if the decision result in the step S57 is YES. In the step S60, the CPU 14 of the transmission apparatus copies the load module having the same version as the acquired load module from the first memory 11 to the second memory 12, and the process advances to a step S61 shown in FIG. 9.

In the step S58, the CPU 14 of the transmission apparatus sends to the host unit 16 a load module send request which requests sending of the load module having the acquired load module name and version. In a step S59, the host unit 16 which receives the load module send request sends the requested load module to the transmission apparatus.

In the step S61 shown in FIG. 9, the CPU 14 of the transmission apparatus receives the load module sent from the host unit 16 and stores the received load module in the second memory 12. Thereafter, in the step S62, the CPU 14 of the transmission apparatus decides whether or not all of the load modules written in the acquired sub configuration file have been received. The process returns to the step S55 shown in FIG. 8 to repeat the steps S55 through S62 if the decision result in the step S62 is NO.

On the other hand, if the decision result in the step S62 is YES, the process advances to a step S63. In the step S63, the CPU 14 of the transmission apparatus replaces the old configuration file stored in the second memory 12 by the main configuration file and the sub configuration file corresponding to the system type of the transmission apparatus, which are within the configuration file for the new program acquired in the step S53. In other words, the old configuration file stored in the second memory 12 is overwritten by the main configuration file and the sub configuration file within the configuration file for the new program. In a step S64, the CPU 14 of the transmission apparatus sends a download complete notification to the host unit 16. Thereafter, in a step S65, the CPU 14 of the transmission apparatus ends the process of downloading the new program.

Next, a description will be given of a first embodiment of the program switching method according to the present invention. When a switch request that requests switching to a new program is generated from the network management apparatus 21, that is, the host unit 16, this embodiment switches to the new program according to the following procedure.

In a first step, the CPU 14 receives the switch request from the host unit 16 requesting switching to the new program.

In a second step, the CPU 14 updates the information stored in the operating program storing memory storage 13, and switches the working memory and the standby memory. Hence, the first memory 11 becomes the standby memory, and the second memory 12 becomes the working memory.

In a third step, the CPU 14 compares load module name and the version developed in the operation memory 15 and the load module name and the version of the sub configuration file for the new program stored in the second memory 12 which is used as the working memory and corresponding to the system type of the transmission apparatus to which the CPU 14 belongs. If the versions of the compared load modules having the same module name differ, the concerned load module within the new program having the same module name and stored in the second memory 12 is developed again in the operation memory 15. In this state, if the information in the sub configuration file, indicating whether or not the CPU 14 is to be restarted, indicates that the CPU 14 is to be restarted, the CPU 14 is restarted. When the CPU 14 is restarted, all of the load modules of the new program stored in the second memory 12 are developed in the operation memory 15.

In addition, the load module which is written in the sub configuration file for the new program but not developed in the operation memory 15 is developed in the operation memory 15. In this state, if the information in the sub configuration file, indicating whether or not the CPU 14 is to be restarted, indicates that the CPU 14 is to be restarted, the CPU 14 is restarted.

Furthermore, the load module which is developed in the operation memory 15 but is not written in the sub configuration file is deleted from the operation memory 15.

By the above described procedure, all of the load modules developed in the operation memory 15 may be regarded as the load modules stored in the second memory 12 which is used as the working memory, to thereby update the operating program. Since it is possible to indicate whether or not the CPU 14 is to be restarted when developing the load module in this state, the updating of the program can be completed without restarting the CPU 14 in the case of an updating of the load module which does not require the restarting of the CPU 14.

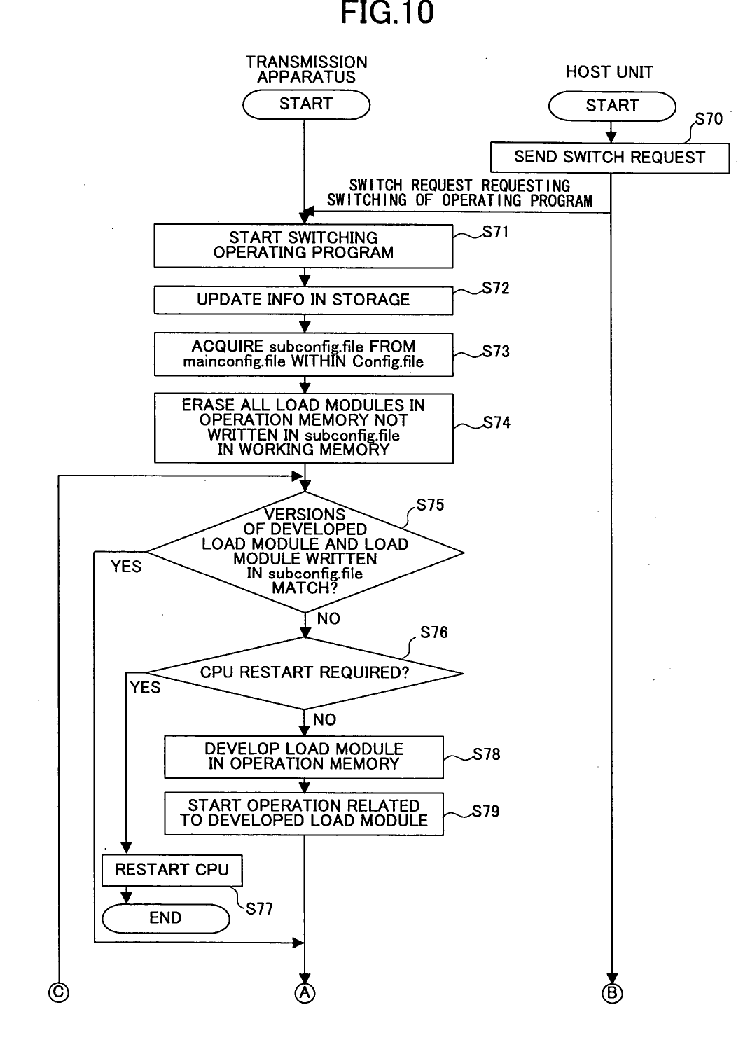

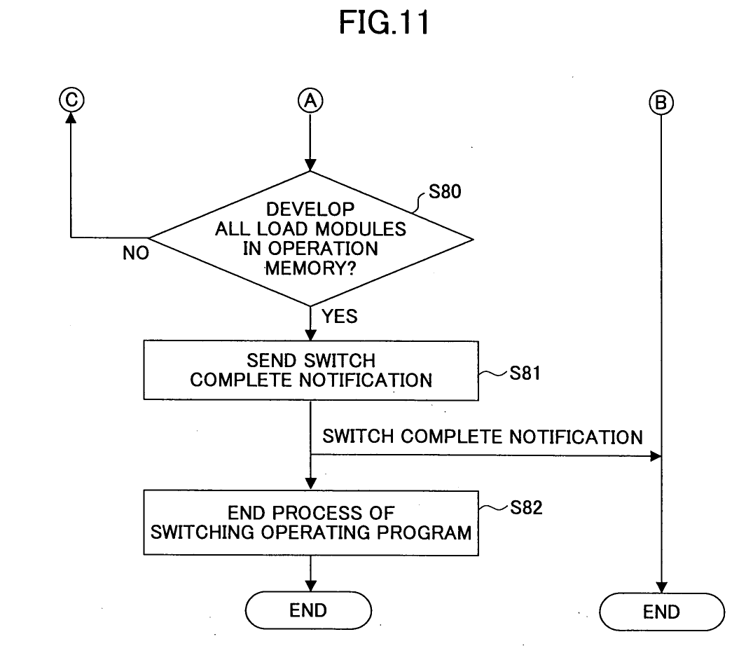

FIGS. 10 and 11 are flow charts for explaining a first embodiment of the program switching method according to the present invention.

In a step S70 shown in FIG. 10, the network management apparatus 21, that is, the host unit 16, sends a switch request requesting switching of the operating program. In a step S71, the CPU 14 of the transmission apparatus which receives the switch request starts a process of switching the operating program. Then, in a step S72, the CPU 14 of the transmission apparatus updates the information stored in the operating program storing memory storage 13, and switches the working memory and the standby memory.

In a step S73, the CPU 14 of the transmission apparatus acquires the sub configuration file corresponding to the system type of the transmission apparatus to which the CPU 14 belongs from the main configuration file within the configuration file for the new program stored in the second memory 12 which is used as the working memory. In a step S74, the CPU 14 of the transmission apparatus erases the load module which is not written in the acquired sub configuration file from the second memory 12, of the load modules developed in the operation memory 15.

Next, in a step S75, the CPU 14 of the transmission apparatus decides whether or not the load module name and the version developed in the operation memory 15 match the load module name and the version of the sub configuration file for the new program acquired from the second memory 12. The process advances to a step S80 shown in FIG. 11 if the decision result in the step S75 is YES, and the process advances to a step S76 if the decision result in the step S75 is NO.

In the step S76, the CPU 14 of the transmission apparatus decides whether or not the information in the sub configuration file, indicating whether or not the CPU 14 is to be restarted, indicates that the CPU 14 is to be restarted. If the decision result in the step S76 is YES, the process advances to a step S77 which restarts the CPU 14. On the other hand, if the decision result in the step S77 is NO, the process advances to a step S78 which develops the concerned load module of the new program stored in the second memory 12 in the operation memory 15, and a step S79 starts an operation related to the developed load module.

After the step S79 or if the decision result in the step S75 is YES, the process advances to the step S80 shown in FIG. 11. In the step S80, the CPU 14 of the transmission apparatus decides whether or not all of the load modules written in the sub configuration file stored in the second memory 12 are developed in the operation memory 15. If the decision result in the step S80 is NO, the process returns to the step S75 shown in FIG. 10 to repeat the steps S75 through S80.

If the decision result in the step S80 is YES, the process advances to a step S81. In the step S81, the CPU 14 of the transmission apparatus sends a switch complete notification indicating the completion of the switching of the operating program to the host unit 16. Thereafter, in a step S82, the CPU 14 of the transmission apparatus ends the process of switching the operating program.

Next, a description will be given of a second embodiment of the program switching method according to the present invention.

If an abnormality of the operating program is generated after the operating program is switched as described above, the operating program may be switched again, that is, re-switched or switched back, to the old operating program according to the following procedure.

In a first step, the CPU 14 receives a re-switch request from the host unit 16 requesting switching to the old program.

In a second step, the CPU 14 updates the information stored in the operating program storing memory storage 13, and switches the working memory and the standby memory. Hence, the first memory 11 becomes the working memory, and the second memory 12 becomes the standby memory.

In a third step, the CPU 14 compares load module name and the version developed in the operation memory 15 and the load module name and the version of the sub configuration file for the old program stored in the first memory 11 which is used as the working memory and corresponding to the system type of the transmission apparatus to which the CPU 14 belongs. If the versions of the compared load modules having the same module name differ, the concerned load module within the old program having the same module name and stored in the first memory 11 is developed again in the operation memory 15. In this state, if the information in the sub configuration file, indicating whether or not the CPU 14 is to be restarted, indicates that the CPU 14 is to be restarted, the CPU 14 is restarted. When the CPU 14 is restarted, all of the load modules of the old program stored in the first memory 11 are developed in the operation memory 15.

In addition, the load module which is written in the sub configuration file for the old program but not developed in the operation memory 15 is developed in the operation memory 15. In this state, if the information in the sub configuration file, indicating whether or not the CPU 14 is to be restarted, indicates that the CPU 14 is to be restarted, the CPU 14 is restarted.

Furthermore, the load module which is developed in the operation memory 15 but is not written in the sub configuration file is deleted from the operation memory 15.

By the above described procedure, all of the load modules developed in the operation memory 15 may be regarded as the load modules stored in the first memory 11 which is used as the working memory, to thereby update the operating program. Since it is possible to indicate whether or not the CPU 14 is to be restarted when developing the load module in this state, the updating of the program can be completed without restarting the CPU 14 in the case of an updating of the load module which does not require the restarting of the CPU 14.

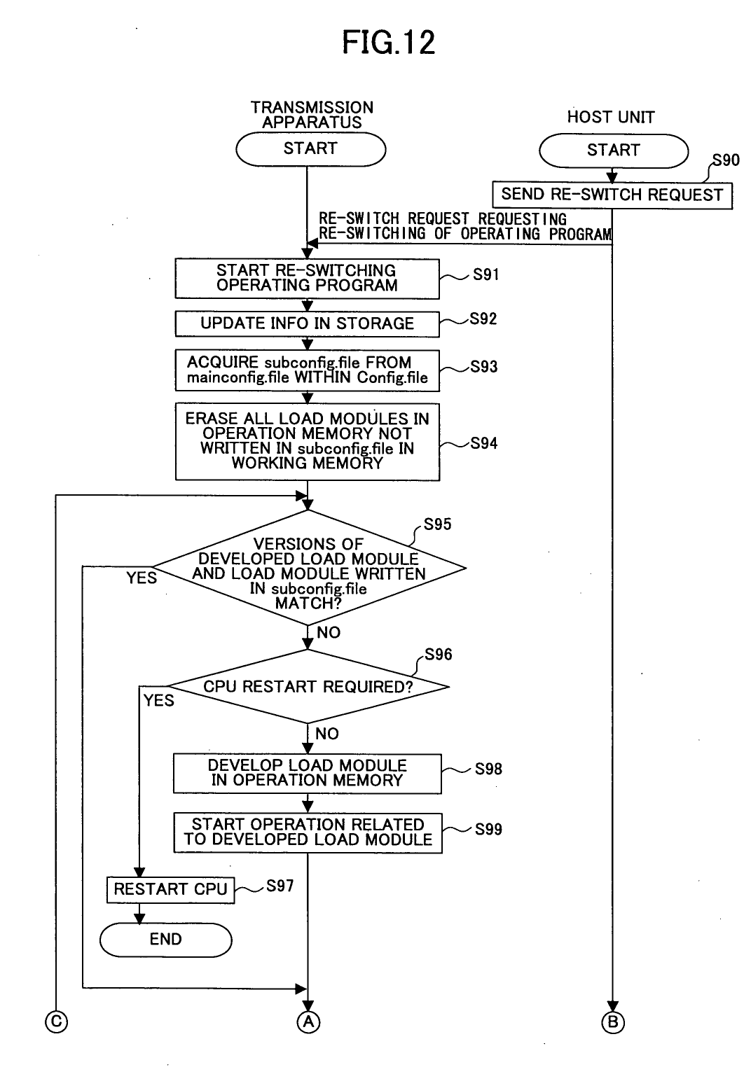

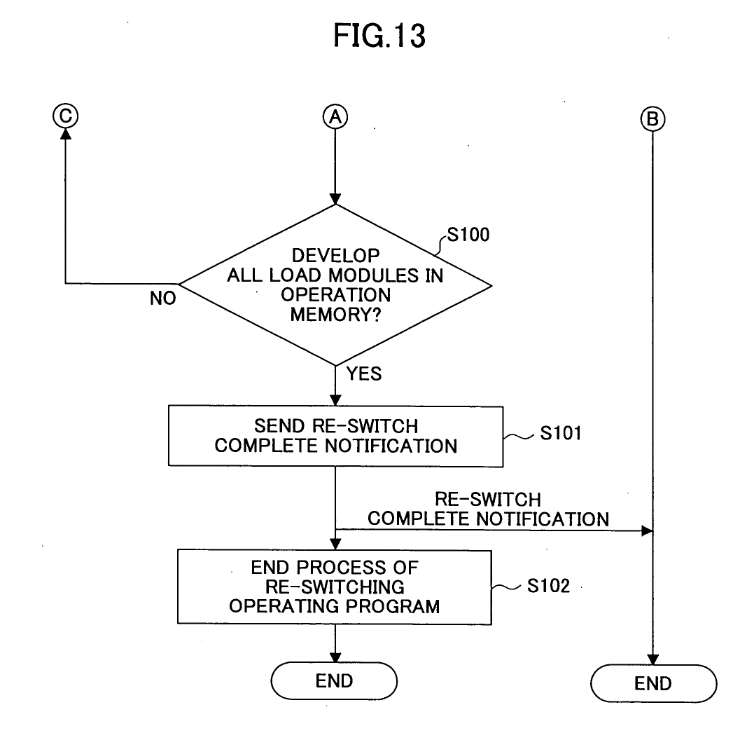

FIGS. 12 and 13 are flow charts for explaining a first embodiment of the program switching method according to the present invention.

In a step S90 shown in FIG. 12, the network management apparatus 21, that is, the host unit 16, sends a re-switch request requesting re-switching of the operating program. In a step S91, the CPU 14 of the transmission apparatus which receives the re-switch request starts a process of re-switching the operating program. Then, in a step S92, the CPU 14 of the transmission apparatus updates the information stored in the operating program storing memory storage 13, and switches the working memory and the standby memory.

In a step S93, the CPU 14 of the transmission apparatus acquires the sub configuration file corresponding to the system type of the transmission apparatus to which the CPU 14 belongs from the main configuration file within the configuration file for the old program stored in the first memory 11 which is used as the working memory. In a step S94, the CPU 14 of the transmission apparatus erases the load module which is not written in the acquired sub configuration file from the first memory 11, of the load modules developed in the operation memory 15.

Next, in a step 95, the CPU 14 of the transmission apparatus decides whether or not the load module name and the version developed in the operation memory 15 match the load module name and the version of the sub configuration file for the old program acquired from the first memory 11. The process advances to a step S100 shown in FIG. 13 if the decision result in the step S95 is YES, and the process advances to a step S96 if the decision result in the step S95 is NO.

In the step S96, the CPU 14 of the transmission apparatus decides whether or not the information in the sub configuration file, indicating whether or not the CPU 14 is to be restarted, indicates that the CPU 14 is to be restarted. If the decision result in the step S96 is YES, the process advances to a step S97 which restarts the CPU 14. On the other hand, if the decision result in the step S97 is NO, the process advances to a step S98 which develops the concerned load module of the old program stored in the first memory 11 in the operation memory 15, and a step S99 starts an operation related to the developed load module.

After the step S99 or if the decision result in the step S95 is YES, the process advances to the step S100 shown in FIG. 13. In the step S100, the CPU 14 of the transmission apparatus decides whether or not all of the load modules written in the sub configuration file stored in the first memory 11 are developed in the operation memory 15. If the decision result in the step S100 is NO, the process returns to the step S95 shown in FIG. 12 to repeat the steps S95 through S100.

If the decision result in the step S100 is YES, the process advances to a step S101. In the step S101, the CPU 14 of the transmission apparatus sends a re-switch complete notification indicating the completion of the re-switching of the operating program to the host unit 16. Thereafter, in a step S102, the CPU 14 of the transmission apparatus ends the process of re-switching the operating program.

Therefore, when downloading the new program, it is possible to reduce the download time by selecting and downloading the load module. In addition, when switching or re-switching the operating program, it is possible to indicate whether or not the CPU is to be restarted depending on the load module to be switched, and for this reason, it is possible to switch an operating program which does not require the restarting of the CPU.

Moreover, even if the load modules to be used differ depending on the system type of the operating program, it is possible to manage the load modules by the same configuration file, thereby facilitating the version management of the system.

The steps S13, S33 and S53 may form an acquiring unit or acquiring means of the network apparatus for acquiring the sub configuration file corresponding to the system type thereof, from the main configuration file within the received configuration file for the new program. The steps S16, S37 and S58 may form a request unit or request means of the network apparatus for sending the load module send request which requests sending of the load module having the acquired load module name and version. The steps S18, S39 and S61 may form a storage unit or storage means of the network apparatus for receiving the load module sent from the host unit and storing the received load module in the standby memory. Further, the step S60 may form a copy unit or copy means for copying the load module having the same version as the acquired load module from the working memory to the standby memory. The steps S71 and S91 may form a switch unit or switch means for switching the working memory and the standby memory.

Of course, in each of the embodiments described above, the downloading of the program and/or the switching of the downloaded program may be carried out with respect to each of the transmission apparatuses 20₁ through 20ₙ forming the ring network which is connected to the network management apparatus 21, that is, the host unit 16.

Further, the present invention is not limited to these embodiments, but various variations and modifications may be made without departing from the scope of the present invention.

1. A program downloading method for downloading a program from a host unit to a plurality of network apparatuses, each of the plurality of network apparatuses having a CPU, an operation memory used for program execution, a working memory and a standby memory, said program downloading method comprising the steps of:
(a) sending a configuration file comprising a main configuration file and a plurality of configuration files from the host unit to the plurality of network apparatuses, said plurality of sub configuration files having a load module name, a version, and information indicating whether or not to restart the CPU when each load module is developed in the operation memory written therein for each system type of the network apparatus, said main configuration file having a correspondence of each of the plurality of sub configuration files and the system type of each of the plurality of network apparatuses written therein;
(b) acquiring in each of the plurality of network apparatuses a sub configuration file corresponding to a system type thereof from the main configuration file of the received configuration file;
(c) making from each of the plurality of network apparatuses a send request requesting the host unit to send a load module name and a version required therein, based on a sub configuration file corresponding to the system type thereof; and
(d) storing in the standby memory of each of the plurality of network apparatuses a load module which is received from the host unit in response to the send request.

2. The program downloading method as claimed in claim 1, further comprising the steps of:
(e) making from each of the plurality of network apparatuses a send request requesting the host unit to send a load module name and a version as a load module required thereby, if a load module having the same load module name and the same version as the load module written in the sub configuration file received from the host unit and corresponding to the system type thereof is not stored in the standby memory.

3. The program downloading method as claimed in claim 2, further comprising the steps of:
(f) copying a load module having the same load module name and the same version as the load module written in the sub configuration file received from the host unit and corresponding to the system type thereof, from the working memory to the standby memory in each of the plurality of network apparatuses, if the load module is not stored in the standby memory but is stored in the working memory, and making from each of the plurality of network apparatuses a send request requesting the host unit to send a load module name and a version as a load module required thereby if the load module is not stored in the standby memory and the working memory.

4. The program downloading method as claimed in claim 1, wherein the plurality of network apparatuses form a ring network which is coupled to the host unit.

5. A program switching method for switching an operation program, after downloading a load module from the host unit to the plurality of network apparatuses according to the program downloading method of claim 1, to the downloaded load module, comprising the steps of:
(i) switching the standby memory to the working memory in each of the plurality of network apparatuses in response to a switch request from the host unit;
(ii) developing from the working memory to the operation memory a load module having the same load module name but a different version, of the load modules developed in the operation memory and the load modules written in the sub configuration file stored in the working memory, and developing from the working memory to the operation memory a load module not developed in the operation memory but written in the sub configuration file stored in the working memory, when developing the load modules stored in the working memory in the operation memory; and
(iii) restarting the CPU if information indicating whether or not the CPU is to be restarted indicates the restarting with respect to the load module developed in the operation memory.

6. A program switching method for re-switching an operation program, after downloading a load module from the host unit to the plurality of network apparatuses according to the program downloading method of claim 1, to the downloaded load module and switching the downloaded load module, comprising the steps of:
(i) switching the standby memory to the working memory in each of the plurality of network apparatuses in response to a re-switch request from the host unit;
(ii) developing from the working memory to the operation memory a load module having the same load module name but a different version, of the load modules developed in the operation memory and the load modules written in the sub configuration file stored in the working memory, and developing from the working memory to the operation memory a load module not developed in the operation memory but written in the sub configuration file stored in the working memory, when developing the load modules stored in the working memory in the operation memory; and
(iii) restarting the CPU if information indicating whether or not the CPU is to be restarted indicates the restarting with respect to the load module developed in the operation memory.

7. A network apparatus to which a program is downloaded from a host unit, comprising:
a CPU;
an operation memory used for program execution by the CPU;
a working memory; and
a standby memory,
said CPU comprising:
an acquiring unit configured to receive from the host unit a configuration file comprising a main configuration file and a plurality of sub configuration file, and to acquire from the main configuration file of the received configuration file a sub configuration file corresponding a system type of the network apparatus, said plurality of sub configuration files having a load module name, a version, and information indicating whether or not to restart the CPU when each load module is developed in the operation memory written therein for each system type of the network apparatus, said main configuration file having a correspondence of each of the plurality of sub configuration files and the system type of each of the plurality of network apparatuses written therein;
a request unit configured to send to the host unit a send request requesting the host unit to send a load module name and a version required by the network apparatus, based on the sub configuration file corresponding to the system type of the network apparatus; and
a storage unit configured to store in the standby memory a load module received from the host unit in response to the send request.

8. The network apparatus as claimed in claim 7, wherein said CPU comprises:
a switch unit configured to switch the working memory and the standby memory, in response to a switch request from the host unit, so that a first memory is used as the working memory and a second memory is used as the standby memory or vice versa.

9. The network apparatus as claimed in claim 7, wherein said request unit makes a send request requesting the host unit to send a load module name and a version as a load module required thereby, if a load module having the same load module name and the same version as the load module written in the sub configuration file received from the host unit and corresponding to the system type thereof is not stored in the standby memory.

10. The network apparatus as claimed in claim 9, wherein said CPU comprises:
a copy unit configured to copy a load module having the same load module name and the same version as the load module written in the sub configuration file received from the host unit and corresponding to the system type thereof, from the working memory to the standby memory, if the load module is not stored in the standby memory but is stored in the working memory; and
said request unit makes a send request requesting the host unit to send a load module name and a version as a load module required thereby if the load module is not stored in the standby memory and the working memory.

11. The network apparatus as claimed in claim 7, wherein said CPU comprises:
a switch unit configured to switch the standby memory to the working memory in response to a switch request from the host unit;
a unit configured to develop from the working memory to the operation memory a load module having the same load module name but a different version, of the load modules developed in the operation memory and the load modules written in the sub configuration file stored in the working memory, and to develop from the working memory to the operation memory a load module not developed in the operation memory but written in the sub configuration file stored in the working memory, when developing the load modules stored in the working memory in the operation memory; and
a unit configured to restart the CPU if information indicating whether or not the CPU is to be restarted indicates the restarting with respect to the load module developed in the operation memory.

12. The network apparatus as claimed in claim 7, wherein said CPU comprises:
a switch unit configured to switch the standby memory to the working memory in response to a re-switch request from the host unit;
a unit configured to develop from the working memory to the operation memory a load module having the same load module name but a different version, of the load modules developed in the operation memory and the load modules written in the sub configuration file stored in the working memory, and to develop from the working memory to the operation memory a load module not developed in the operation memory but written in the sub configuration file stored in the working memory, when developing the load modules stored in the working memory in the operation memory; and
a unit configured to restart the CPU if information indicating whether or not the CPU is to be restarted indicates the restarting with respect to the load module developed in the operation memory.
